(19) United States
(12) Patent Application Publication
(10) Pub. No.: US 2011/0222567 A1
(43) Pub. Date: Sep. 15, 2011

(54) OPTOELECTRONIC TRANSISTOR OUTLINE (TO)-CAN HEADER ASSEMBLY HAVING A CONFIGURATION THAT IMPROVES HEAT DISSIPATION AND REDUCES THERMAL RESISTANCE

(75) Inventors: Marco Scofet, Rivarolo Canavese (IT); Luigi Tallone, Paesana (IT); Stefano Genisio, Torino (IT)

(73) Assignee: AVAGO TECHNOLOGIES FIBER IP (SINGAPORE) PTE. LTD., SINGAPORE (SG)

(21) Appl. No.: 12/720,043

(22) Filed: Mar. 9, 2010

(51) Int. Cl. H01S 3/04

(52) U.S. Cl. 372/36

(57) ABSTRACT

A TO-can header assembly is provided that has improved heat dissipation and thermal resistance characteristics. The TO-can header assembly includes a relatively large ceramic heat dissipation block that functions as both a carrier for the laser diode and as a heat dissipation device. The ceramic heat dissipation block is in contact with the upper mounting surface of the header to allow a relatively large amount of heat to quickly pass from the laser diode through the heat dissipation block and into the upper mounting surface of the header. The cylindrical side wall of the header is smooth, rather than notched, and at least a substantial portion of the smooth cylindrical side wall is in continuous contact with an external heat sink device. Heat moves rapidly from the header into the external heat sink device where it is dissipated, thereby reducing the thermal resistance of the header.

### TECHNICAL FIELD OF THE INVENTION

The invention relates to optical fiber transceiver modules that are implemented as transistor outline (TO)-can header assemblies. More particularly, the invention relates to a TO-can header assembly that has improved heat dissipation characteristics and reduced thermal resistance.

### BACKGROUND OF THE INVENTION

Optical transceiver modules that are implemented as TO-can header assemblies typically include a cylindrical base, known as a header, four or five conductive leads having ends that pass through the header, a laser diode mounted on a mounting surface of the header and connected to the ends of two of the conductive leads, a photodiode mounted on the mounting surface of the header and connected to the ends of two of the other conductive leads, and a cap that is sealed to the header. The cap encases and protects the laser diode, photodiode and other electrical devices (e.g., resistors, capacitors, etc.) mounted on the mounting surface of the header. One or more transparent windows exist in the cap to allow light to be coupled between ends of transmit and receive optical fibers and the laser diode and photodiode, respectively.

An optics system is often also mounted on the mounting surface of the header to direct light between the ends of the transmit optical fiber and the receive optical fiber and the laser diode and photodiode, respectively. The TO-can header assembly is typically mounted on a printed circuit board (PCB) on which other electrical devices are also mounted, such as a transmitter integrated circuit (IC), a receiver IC and a controller IC. The ends of the leads opposite the ends that pass through the header are electrically connected to contacts on the PCB to enable the ICs to communicate with one or more of the active devices (i.e., the laser diode and photodiode) mounted on the mounting surface of the header.

One of the major concerns with TO-can header assemblies is that they have inadequate heat dissipation and thermal resistance characteristics. The laser diode generates a significant amount of heat. If the heat generated by the laser diode is not adequately dissipated, the heat can adversely affect the operations of the laser diode. Therefore, TO-can header assemblies are provided with heat dissipation pathways by which heat generated by the laser diode is moved away from the laser diode. These pathways have a thermal resistance that tends to impede the movement of thermal energy along the pathways. For these reasons, steps are taken to reduce the thermal resistance along these pathways in order to improve the heat dissipation characteristics of the TO-can header assembly.

FIGS. 1A and 1B depict side and top plan views, respectively, of a typical TO-can header assembly used as an optical transmitter. This particular TO-can header assembly 2 includes a header 3, which is typically made of a thermally conductive material such as metal, three leads 4, a thermally conductive stem 5, a small ceramic carrier 6, and a laser diode 7 mounted on the ceramic carrier 6. The laser diode 7 is typically mounted on the ceramic carrier 6 using gold or tin solder (not shown). Electrical contacts on the laser diode 7 are connected by bond wires (not shown) to the leads 4 during a wire bonding process.

The header 3 has an upper mounting surface 3a, a generally cylindrical side wall 3b and a lower surface 3c. The generally cylindrical side wall 3b has notches 3d, 3d′ and 3d″ formed therein for mating with complimentarily-shaped mating features (not shown) formed on a chassis (not shown) on which the TO-can header assembly 2 will ultimately be mounted. Heat generated by the laser diode 7 is transferred into the ceramic carrier 6. From the ceramic carrier 6, the heat is transferred into the stem 5. From the stem 5, the heat is transferred into the header 3 where it is spread over the mounting surface 3a of the header 3. The heat that is spread over the mounting surface 3a of the header 3 is then removed through natural convection and/or through thermal conduction into the chassis (not shown) on which the TO-can header assembly 2 is mounted.

One of the disadvantages of the TO-can header assembly 2 and others like it is that the thermal dissipation pathways (from the laser diode 7 through the ceramic carrier 6, from the carrier 6 into the stem 5, and through the stem 5 into the mounting surface 3a of the header 3) are relatively great in length. The relatively great lengths of these pathways cause the header 3 to have a relatively high thermal resistance. The relatively high thermal resistance of the header 3 can adversely affect the performance of the laser diode 7, particularly when it is operating at high operating temperatures and high electrical currents. While a variety of TO-can header assemblies are configured to improve heat dissipation and thermal resistance characteristics, the current designs are inadequate at dissipating heat and/or are not economical in terms of costs. For example, one way to improve the heat dissipation characteristics of the TO-can header assembly shown in FIGS. 1A and 1B is to increase the diameter of the header 3. However, increasing the diameter of the header 3 has the undesirable side effect of increasing both the costs associated with assembly 2 and the overall size of the assembly 2.

Accordingly, a need exists for a TO-can header assembly that is effective at dissipating heat and that is economical in terms of costs.

### SUMMARY OF THE INVENTION

The invention is directed to a TO-can header assembly having improved heat dissipation and thermal resistance and a method for dissipating heat in a TO-can header assembly. In accordance with one embodiment, the TO-can header assembly comprises a header, a plurality of electrically conductive leads, a ceramic heat dissipation block, an electrical ground contact pad, an electrical bias contact pad, and a laser diode. The header has an upper mounting surface, a lower surface, and a generally cylindrical side wall that interconnects the upper mounting surface and the lower surface. Each of the electrically conductive leads extends through the header and has a first end and a second end. The ceramic heat dissipation block has at least an upper surface, a lower surface, and at least one mounting surface. The lower surface of the ceramic heat dissipation block is thermally coupled with the upper mounting surface of the header. The electrical ground contact pad is mounted on the mounting surface of the ceramic heat dissipation block and is in abutment with the second end of a first of the electrically conductive leads. The electrical bias contact pad is mounted on the mounting surface of the ceramic heat dissipation block and is in abutment with a second end of a second of the electrically conductive leads. The laser diode is mounted on the mounting surface of the ceramic heat dissipation block. The laser diode has an anode that is electrically coupled to one of the contact pads and a cathode that is electrically coupled to the other of the contact pads. At least a portion of the heat produced by the laser diode during operation of the laser diode passes into the ceramic heat dissipation block and then passes from the ceramic heat dissipation block into the header. The heat that passes into the header spreads through at least a portion of the header.

In accordance with another embodiment, the TO-can header assembly comprises a header, a plurality of electrically conductive leads, a ceramic heat dissipation block, an electrical ground contact pad, an electrical bias contact pad, a laser diode, and an external heat sink block. The header has an upper mounting surface, a lower surface, and a generally cylindrical side wall that interconnects the upper mounting surface and the lower surface. Each of the electrically conductive leads extends through the header and has a first end and a second end. The ceramic heat dissipation block has at least an upper surface, a lower surface, and at least one mounting surface. The lower surface of the ceramic heat dissipation block is thermally coupled with the upper mounting surface of the header. The electrical ground contact pad is mounted on the mounting surface of the ceramic heat dissipation block. The electrical ground contact pad is electrically coupled to a second end of a first one of the electrically conductive leads. The laser diode is mounted on the mounting surface of the ceramic heat dissipation block and has an anode that is electrically coupled to one of the contact pads and a cathode that is electrically coupled to the other of the contact pads. At least a portion of heat produced by the laser diode passes into the ceramic heat dissipation block and then passes from the ceramic heat dissipation block into the header and spreads through at least a portion of the header. The external heat sink device has a heat transfer surface that is in contact with at least a portion of the cylindrical side wall of the header. The heat transfer surface has a shape that is complimentary to the shape of the portion of the cylindrical side wall that is in contact with the heat transfer surface. At least a portion of the heat that passes from the ceramic heat dissipation block into the header and from the header into the external heat sink device where the heat is dissipated.

The method comprises providing a TO-can header assembly having one of the configurations described above and providing a voltage differential between at least the first and second electrically conductive leads to cause the laser diode to be modulated. As the laser diode is modulated, heat is produced by the laser diode. At least a portion of the heat produced by the laser diode passes into the ceramic heat dissipation block and then is passed from the ceramic heat dissipation block into the header.

These and other features and advantages of the invention will become apparent from the following description, drawings and claims.

### BRIEF DESCRIPTION OF THE DRAWINGS

FIGS. 1A and 1B depict side and top plan views, respectively, of a typical TO-can header assembly used as an optical transmitter.

FIG. 2 illustrates a side perspective view of a partially assembled TO-can header assembly of the invention in accordance with an illustrative embodiment.

FIG. 3 illustrates a side perspective view of the TO-can header assembly 10 shown in FIG. 2 after the TO-can header assembly has been fully assembled with a ceramic heat dissipation block 40 mounted on the upper mounting surface 20a of the header 20 and various bond wires connected.

FIG. 4 illustrates a side perspective view of another illustrative embodiment of a TO-can header assembly of the invention.

### DETAILED DESCRIPTION OF AN ILLUSTRATIVE EMBODIMENT

In accordance with the invention, a TO-can header assembly is provided that has improved heat dissipation and thermal resistance characteristics. The TO-can header assembly includes a relatively large ceramic heat dissipation block that functions as both a carrier for the laser diode and as a heat dissipation device. A relatively large surface area of the ceramic heat dissipation block is in contact with the upper mounting surface of the header, which allows a relatively large amount of heat to quickly pass from the laser diode through the ceramic heat dissipation block and into the upper mounting surface of the header. The heat then quickly spreads through the mounting surface of the header and is at least partially dissipated.

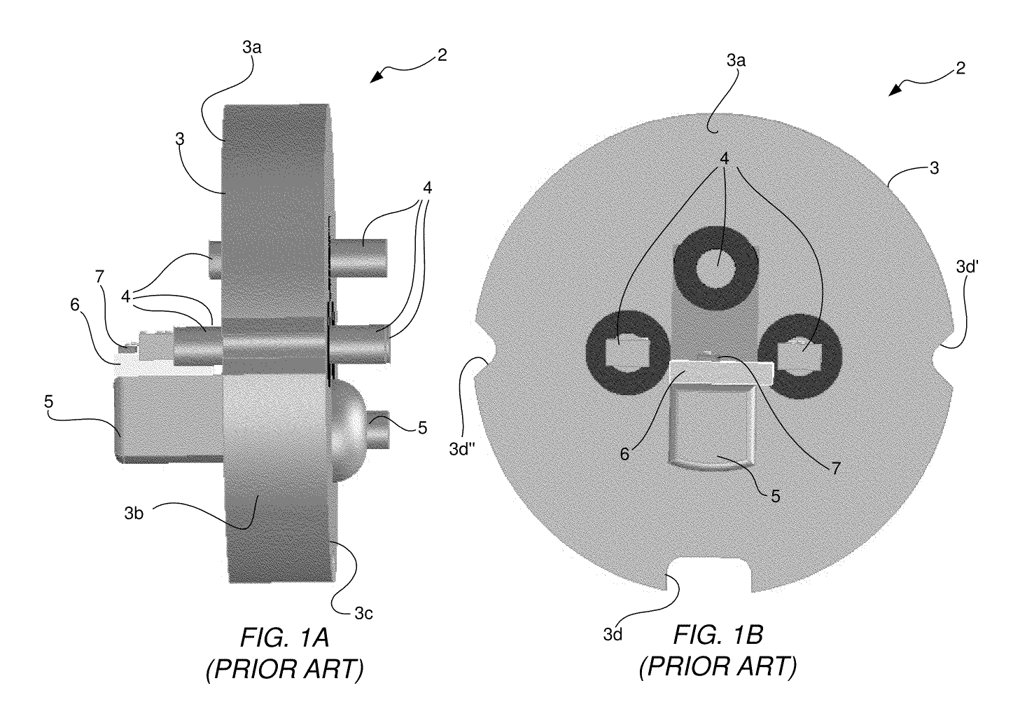

In addition, the cylindrical side wall of the header is smooth, rather than being notched (elimination of notches 3d, 3d′ and 3d″ in FIG. 1B). At least a substantial portion of the smooth cylindrical side wall is in continuous contact with an external heat sink device. A surface of the external heat sink device that is in contact with the smooth cylindrical side wall of the header has a shape that is complimentary to the shape of the smooth cylindrical side wall. Because of the complimentary shapes of these surfaces, heat moves rapidly from the header into the external heat sink device where it is dissipated. Thus, the external heat sink device rapidly removes heat from the header, thereby reducing the thermal resistance of the header.

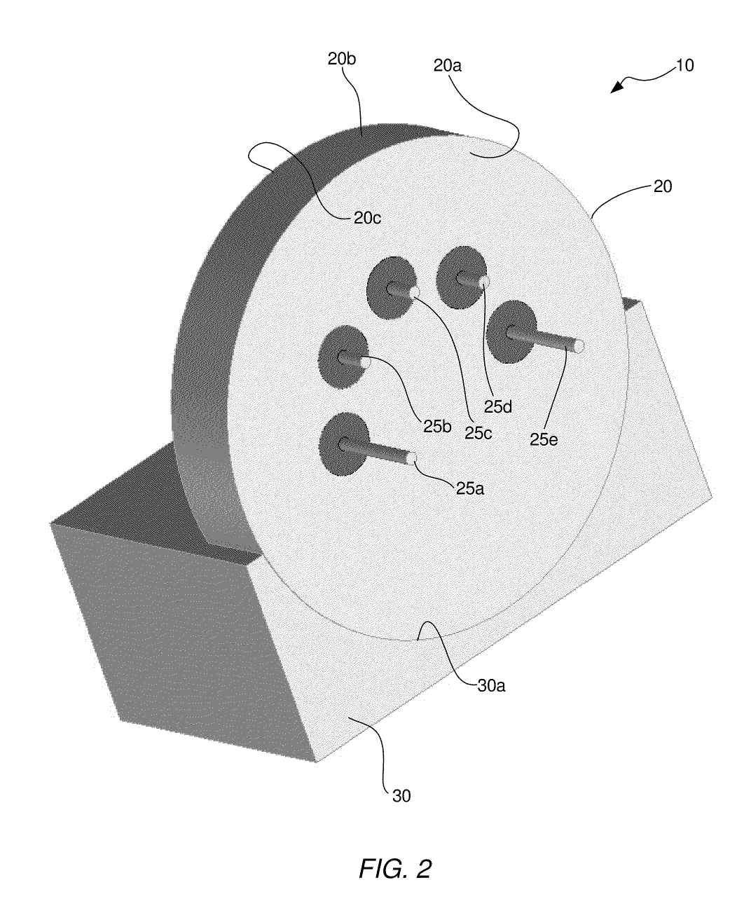

Thus, the large ceramic heat dissipation block mounted on the header, the smooth cylindrical side wall of the header, and the external heat sink device in contacted with the header cooperate with one another to rapidly dissipate heat generated by the laser diode. This rapid dissipation of heat reduces the thermal resistance of the header and ensures that the header is maintained at a temperature that is substantially equal to the temperature of the chassis on which the TO-can header assembly is mounted or the housing in which the TO-can header assembly is housed. Consequently, the laser diode has a longer lifetime and a wider range of operating temperatures than laser diodes that are used in other TO-can header assemblies, such as that shown in FIGS. 1A and 1B. The TO-can header assembly in accordance with illustrative, or exemplary, embodiments will now be described with reference to FIGS. 2-4.

FIG. 2 illustrates a side perspective view of a partially assembled TO-can header assembly 10 in accordance with an illustrative embodiment. The partially assembled TO-can header assembly 10 includes a header 20, a plurality of electrically conductive leads 25a-25e that extend through the header 20, and an external heat sink device 30 that is in contact with the header 20. The header 20 has an upper mounting surface 20a, a smooth cylindrical side wall 20b, and a lower surface 20c. The external heat sink device 30 has a heat transfer surface 30a that has a shape that is complimentary to the shape of the smooth cylindrical side wall 20b of the header 20. The header 20 and the external heat sink device 30 are both made of thermally conductive materials. The header 20 is typically made of a metallic material, such as steel, for example, which has a high thermal conductivity. The external heat sink device 30 is also typically made of a metallic material, such as copper, for example, which also has a high thermal conductivity.

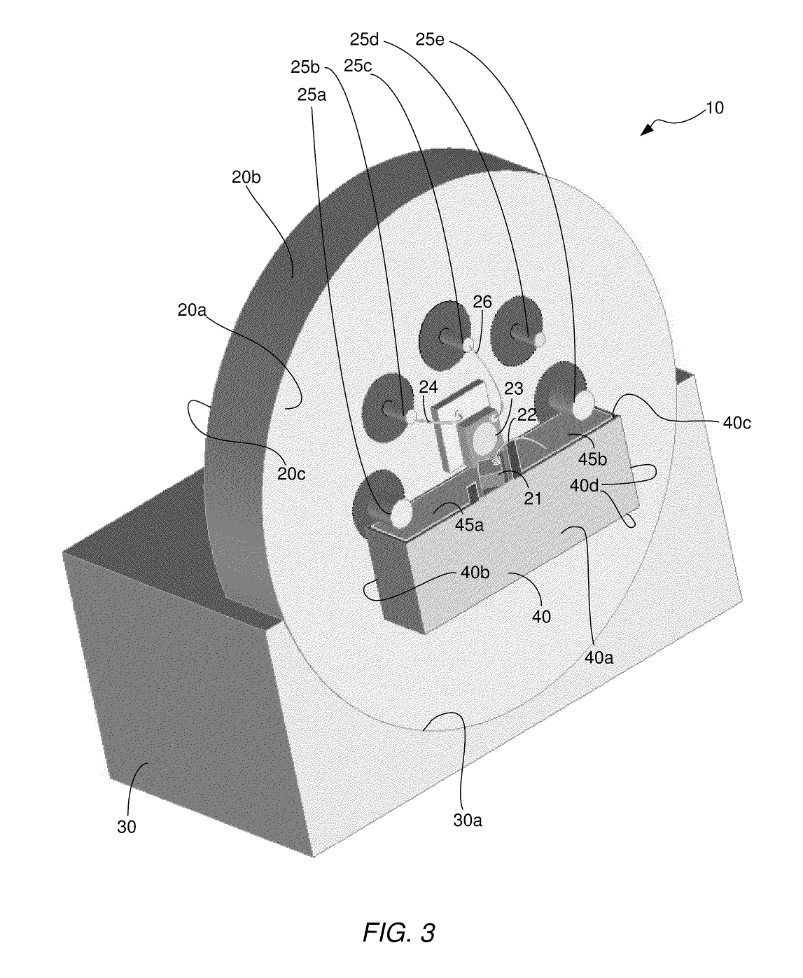

FIG. 3 illustrates a side perspective view of the TO-can header assembly 10 shown in FIG. 2 after the TO-can header assembly has been fully assembled with a ceramic heat dissipation block 40 mounted on the upper mounting surface 20a of the header 20 and various bond wires connected. The ceramic heat dissipation block 40 functions as both a carrier for a laser diode 21 and has a heat dissipation device for dissipating heat produced by the laser diode 21. The ceramic heat dissipation block 40 has an upper surface 40a, a lower surface 40b, a mounting surface 40c, and one or more other surfaces 40d. In accordance with this illustrative embodiment, the ceramic heat dissipation block 40 is generally rectangular in shape. The lower surface 40b of the ceramic heat dissipation block 40 is in contact with the upper mounting surface 20a of the header 20. Typically, the ceramic heat dissipation block 40 is secured to the upper mounting surface 20a of the header 20 with a thermally conductive adhesive material, such as epoxy, that is disposed between the lower surface 40b of the heat dissipation block 40 and the upper mounting surface 20a of the header 20.

The ceramic heat dissipation block 40 has an electrical ground contact pad 45a and an electrical bias contact pad 45b positioned on the mounting surface 40c thereof. The laser diode 21 is mounted on the mounting surface 40c of the ceramic heat dissipation block 40 such that an anode (not shown) on a bottom portion of the laser diode 21 is in contact with the electrical ground contact pad 45a. A bond wire 22 electrically connects a cathode (not shown) located on a top portion of the laser diode 21 with the electrical bias contact pad 45b. The electrical ground contact pad 45a and the electrical bias contact pad 45b are in abutment with two of the leads 25a and 25e, respectively, to allow a bias voltage differential to be created between the cathode and the anode of the laser diode 21 and varied to electrically modulate the laser diode 21. If the TO-can header assembly 10 is implemented as a transceiver, the assembly 10 may also include a photodiode 23 that is mounted on the header 20. The photodiode 23 has an anode (not shown) and a cathode (not shown) that are connected via bond wires 24 and 26 to leads 25b and 25d, respectively.

The ceramic heat dissipation block 40 is significantly larger than the ceramic carrier 6 shown in FIG. 1. As indicated above with reference to FIG. 1, the heat produced by the laser diode 7 of the known TO-can assembly 2 passes from the laser diode 7 into the carrier 6, from the carrier 6 into the stem 5, and from the stem 5 into the header 3. This pathway over which the heat must travel before being spread through the header 3 and dissipated is relatively long and results in the header 3 having a relatively high thermal resistance. In contrast, the ceramic heat dissipation block 40 shown in FIG. 3 is in direct contact with the upper mounting surface 20a of the header 20. Thus, the stem 5 shown in FIG. 1 is no longer needed as the heat produced by the laser diode 21 shown in FIG. 3 passes from the ceramic heat dissipation block 40 directly into the upper surface 20a of the header 20. The larger size of the ceramic heat dissipation block 40 and its rectangular shape results in a large amount of surface area on its lower surface 40b being in contact with an equal amount of surface area on the upper surface 20a of the header 20. This large interface between the surfaces 20a and 40b allows heat to rapidly flow from the laser diode 21 into the header 20, thereby reducing the thermal resistance of the header 20. The ceramic heat dissipation block 40 may comprise, for example, aluminum nitride, which has a very high thermal conductivity (e.g., 170 W/mK), although other thermally conductive materials may be used for this purpose.

In addition, the heat dissipation characteristics of the TO-can header assembly 10 are further improved by incorporation of the external heat sink device 30 into the assembly 10. At least at the interface where the cylindrical side wall 20b of the header 20 is in contact with the surface 30a of the external heat sink device 30, the cylindrical side wall 20b is smooth rather than notched. The external heat sink device 30 has a surface 30a that is complimentary in shape to the shape of the smooth cylindrical side wall 20b of the header 20. Because of the complimentary shapes of these surfaces, and because of the relatively large area over which these surfaces are in continuous contact with one another, the heat that flows from the ceramic heat dissipation block 40 into the header 20 is rapidly transferred into the external heat sink device 30 where it is dissipated. Some of the heat that flows into the header 20 may be dissipated through convection before it has an opportunity to flow from the header 20 into the external heat sink device 30.

The result of all these components cooperating to dissipate heat is that the header 20 is generally maintained at a temperature that is about the same as the temperature of the chassis or housing (not shown) in which the TO-can header assembly 10 is mounted. Consequently, the laser diode 21 has a longer lifetime and is able to operate over a wider range of operating temperatures than laser diodes that are used in other TO-can header assembly designs, such as that shown in FIG. 1, for example.

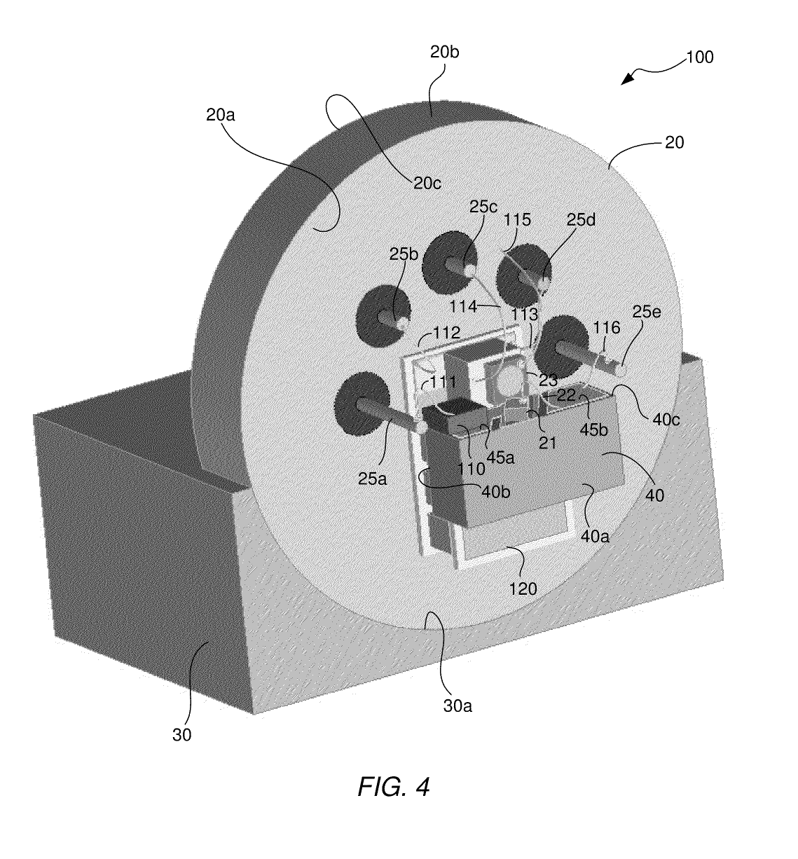

The embodiments of the invention described above utilize a passive heat dissipation configuration and method. FIG. 4 illustrates another illustrative embodiment directed to a configuration of a TO-can header assembly 100 that utilizes an active heat dissipation configuration and method. In particular, the TO-can header assembly 100 shown in FIG. 4 is identical to the TO-can header assembly 10 shown in FIGS. 2 and 3 and described above except that the TO-can header assembly 100 shown in FIG. 4 also includes a thermistor 110 and a Peltier heat pump 120, both of which are known devices in the art. The thermistor 110 is a semiconductor device that has a resistance that varies as the temperature of the thermistor 110 varies. The Peltier heat pump 120 is a device that, when activated, causes heat to be pumped (i.e., transferred) from the ceramic heat dissipation block 40 into the header 20.

Like numerals in FIGS. 2, 3 and 4 represent like components. The Peltier heat pump 120 is mounted on the mounting surface 20a of the header 20. First and second electrodes (not shown) of the Peltier heat pump 120 are connected via bond wires 112 and 113, respectively, to leads 25b and 25d, respectively. The thermistor 110 has first and second electrodes (not shown) on the top and bottom surfaces thereof, respectively. The thermistor 110 is mounted on the mounting surface 40c of the ceramic heat dissipation block 40 such that the second electrode on the bottom surface of the thermistor 110 is in contact with the electrical ground contact pad 45a. The first electrode on the top surface of the thermistor 110 is connected via a bond wire 111 to lead 25a. The cathode and anode of the photodiode 23 are connected via bond wires 114 and 115 to lead 25c and to the upper mounting surface 20a, respectively, of the header 20. The cathode of the laser diode 21 is connected via the bond wire 22 to the electrical bias contact pad 45b. The anode of the laser diode 21 is in contact with the electrical ground bias pad 45a through the aforementioned mounting arrangement.

During operations, electrical power is provided to the laser diode 21 and the laser diode 21 can be modulated by changing the voltage potential difference between leads 25a and 25e to cause the laser diode 21 to produce a modulated optical signal. During operations, heat produced by the laser diode 21 is transferred via the ceramic heat dissipation block 40 into the header 20. As heat is transferred from the laser diode 21 into the header 20, the temperature of the thermistor 110 increases. If the temperature of the thermistor 110 increases to a particular threshold temperature, the increase in temperature will cause the Peltier heat pump 120 to be activated. When the Peltier heat pump 120 is activated, it pumps heat from the ceramic heat dissipation block 140 into the header 20.

As the Peltier heat pump 120 pumps heat from the ceramic heat dissipation block 140 into the header 20, the thermistor 110 begins to cool. Once the temperature of the thermistor 110 has cooled to a temperature that is below the threshold temperature, the Peltier heat pump 120 is deactivated. As the laser diode 21 continues to operate, the heat it produces causes the temperature of the thermistor 110 to again increase. Once the temperature of the thermistor 110 has reached the threshold temperature, the Peltier heat pump 120 turns on again causing heat to be pumped from the ceramic heat dissipation block 40 into the header 20. This causes the thermistor 110 to cool again until its temperature drops below the threshold temperature.

The foregoing process of the Peltier heat pump 120 being activated and deactivated based on the temperature of the thermistor 110 ensures that the header 20 is maintained at a substantially constant temperature that is approximately equal to the chassis (not shown) to which the assembly 100 is mounted or the housing (not shown) in which the assembly 100 is housed. This, in turn, ensures that the laser diode 21 will have a long lifetime and can operate over a wider range of operating temperatures than that which is possible for laser diodes used in other TO-can header assembly designs, such as that shown in FIGS. 1A and 1B.

Another advantage of the TO-can header assemblies 10 and 100 shown in FIGS. 2-4 is that they are relatively easy to assemble. During assembly, the laser diode 21 is first attached to the ceramic heat dissipation block 40 and typical burn-in and testing processes are performed. Subsequent to the performance of the testing and burn-in processes, the ceramic heat dissipation block 40 having the laser diode 21 attached thereto is attached to the header 20 such that the electrical ground and bias contact pads 45a and 45b, respectively, are pressed against the leads 25a and 25e, respectively. Therefore, no wire bonding connections need to be made between the pads 45a and 45b and the leads 25a and 25e, respectively. This feature greatly simplifies the overall assembly process in that it eliminates the need to perform wire bonding on orthogonal planes. In addition, eliminating the bond wires that would otherwise been needed to make these connections minimizes parasitic inductance that can result from bond wires.

It should be noted that the invention has been described with reference to a few illustrative, or exemplary, embodiments for the purposes of demonstrating the principles and concepts of the invention. Those of ordinary skill in the art will understand that the invention is not limited to these embodiments. For example, although the ceramic heat dissipation block 40 and the external heat sink device 30 have been described above as having particular shapes and comprising particular materials, other shapes and materials may be used for these components. As another example, the TO-can header assemblies 10 and 100 are not limited to having any particular number of leads and are not limited with respect to the manner in which the leads are electrically coupled to components of the assemblies. As yet another example, although the header 20 is shown as having a smooth cylindrical side wall 20b, the side wall 20b need not be strictly cylindrical in shape or smooth over its entire surface. Rather, the shape of the side wall 20b is generally cylindrical in that there may be variations in its shape (e.g., flanges, tapers, etc.). The surface of the side wall 20b need only be smooth and in continuous contact with the heat transfer surface 30a of the external heat sink device 30 at the interface between the side wall 20b and the heat transfer surface 30a. If these surfaces are not smooth and in continuous contact with each other, then the ability of heat to be adequately transferred between these surfaces may be less than adequate.

As will be understood by persons of ordinary skill in the art, these and other modifications may be made to the embodiments described above with reference to FIGS. 2-4, and all such modifications are within the scope of the invention.

What is claimed is:

1. A transistor outline (TO)-can header assembly comprising:
a header having an upper mounting surface, a lower surface, and a generally cylindrical side wall that interconnects the upper mounting surface and the lower surface;
a plurality of electrically conductive leads, each lead extending through the header and having a first end and a second end;
a ceramic heat dissipation block having at least an upper surface, a lower surface, and at least one mounting surface, the lower surface of the ceramic heat dissipation block being thermally coupled with the upper mounting surface of the header;
an electrical ground contact pad mounted on the mounting surface of the ceramic heat dissipation block, the electrical ground contact pad being in abutment with a second end of a first one of the electrically conductive leads;
an electrical bias contact pad mounted on the mounting surface of the ceramic heat dissipation block, the electrical bias contact pad being in abutment with a second end of a second one of the electrically conductive leads; and
a laser diode mounted on the mounting surface of the ceramic heat dissipation block, the laser diode having an anode that is electrically coupled to one of the contact pads and a cathode that is electrically coupled to the other of the contact pads, wherein at least a portion of heat produced by the laser diode passes into the ceramic heat dissipation block and then passes from the ceramic heat dissipation block into the header and spreads through at least a portion of the header.

2. The TO-can header assembly of claim 1, further comprising:
an external heat sink device having a heat transfer surface that is in contact with at least a portion of the cylindrical side wall of the header, the heat transfer surface having a shape that is complimentary to a shape of the portion of the cylindrical side wall that is in contact with the heat transfer surface, and wherein at least a portion of the heat that passes from the ceramic heat dissipation block into the header passes from the header into the external heat sink device where the heat is dissipated.

3. The TO-can header assembly of claim 2, wherein the cylindrical side wall of the header comprises a smooth surface.

4. The TO-can header assembly of claim 3, wherein the external heat dissipation device comprises copper.

5. The TO-can header assembly of claim 3, wherein the ceramic heat dissipation block comprises aluminum nitride.

6. The TO-can header assembly of claim 3, wherein the header comprises steel.

7. The TO-can header assembly of claim 1, wherein the assembly comprises three of said electrically conductive leads.

8. The TO-can header assembly of claim 1, wherein the assembly comprises four of said electrically conductive leads.

9. The TO-can header assembly of claim 1, wherein the assembly comprises five of said electrically conductive leads.

10. The TO-can header assembly of claim 1, wherein the lower surface of the ceramic heat dissipation block is thermally coupled with the upper mounting surface of the header by virtue of the lower surface of the ceramic heat dissipation block being in contact with the upper mounting surface of the header.

11. The TO-can header assembly of claim 1, further comprising:
a heat pump having an upper surface and a lower surface, the lower surface of the heat pump being in contact with the upper mounting surface of the header, the upper surface of the heat pump being in contact with the lower surface of the ceramic heat dissipation block such that the heat pump thermally couples the lower surface of the ceramic heat dissipation block with the upper mounting surface of the header, and wherein if the heat pump is activated, the heat pump causes at least a portion of the heat that has passed from the laser diode into the ceramic heat dissipation block to be pumped from the ceramic heat dissipation block into the header.

12. The TO-can header assembly of claim 11, further comprising:
a thermistor mounted on the mounting surface of the ceramic heat dissipation device, the thermistor sensing a temperature of the ceramic heat dissipation block, wherein the heat pump is activated when the thermistor senses that the temperature is equal to or greater than a threshold temperature, and wherein the heat pump is deactivated when the thermistor senses that the temperature is less than the threshold temperature.

13. A transistor outline (TO)-can header assembly comprising:
a header having an upper mounting surface, a lower surface, and a generally cylindrical side wall that interconnects the upper mounting surface and the lower surface;
a plurality of electrically conductive leads, each lead extending through the header and having a first end and a second end;
a ceramic heat dissipation block having at least an upper surface, a lower surface, and at least one mounting surface, the lower surface of the ceramic heat dissipation block being thermally coupled with the upper mounting surface of the header;
an electrical ground contact pad mounted on the mounting surface of the ceramic heat dissipation block, the electrical ground contact pad being electrically coupled to a second end of a first one of the electrically conductive leads;
an electrical bias contact pad mounted on the mounting surface of the ceramic heat dissipation block, the electrical bias contact pad being electrically coupled to a second end of a second one of the electrically conductive leads;
a laser diode mounted on the mounting surface of the ceramic heat dissipation block, the laser diode having an anode that is electrically coupled to one of the contact pads and a cathode that is electrically coupled to the other of the contact pads, wherein at least a portion of heat produced by the laser diode passes into the ceramic heat dissipation block and then passes from the ceramic heat dissipation block into the header and spreads through at least a portion of the header; and
an external heat sink device having a heat transfer surface that is in contact with at least a portion of the cylindrical side wall of the header, the heat transfer surface having a shape that is complimentary to a shape of the portion of the cylindrical side wall that is in contact with the heat transfer surface, and wherein at least a portion of the heat that passes from the ceramic heat dissipation block into the header passes from the header into the external heat sink device where the heat is dissipated.

14. The TO-can header assembly of claim 13, wherein the cylindrical side wall of the header comprises a smooth surface.

15. The TO-can header assembly of claim 14, wherein the external heat dissipation device comprises copper.

16. The TO-can header assembly of claim 14, wherein the ceramic heat dissipation block comprises aluminum nitride.

17. The TO-can header assembly of claim 14, wherein the header comprises steel.

18. The TO-can header assembly of claim 13, wherein the assembly comprises three of said electrically conductive leads.

19. The TO-can header assembly of claim 13, wherein the assembly comprises four of said electrically conductive leads.

20. The TO-can header assembly of claim 13, wherein the assembly comprises five of said electrically conductive leads.

21. The TO-can header assembly of claim 13, further comprising:
a heat pump having an upper surface and a lower surface, the lower surface of the heat pump being in contact with the upper mounting surface of the header, the upper surface of the heat pump being in contact with the lower surface of the ceramic heat dissipation block such that the heat pump thermally couples the lower surface of the ceramic heat dissipation block with the upper mounting surface of the header, and wherein if the heat pump is activated, the heat pump causes at least a portion of the heat that has passed from the laser diode into the ceramic heat dissipation block to be pumped from the ceramic heat dissipation block into the header.

22. The TO-can header assembly of claim 18, further comprising:
a thermistor mounted on the mounting surface of the ceramic heat dissipation device, the thermistor sensing a temperature of the ceramic heat dissipation block, wherein the heat pump is activated when the thermistor senses that the temperature is equal to or greater than a threshold temperature, and wherein the heat pump is deactivated when the thermistor senses that the temperature is less than the threshold temperature.

23. A method for dissipating heat in a transistor outline (TO)-can header assembly, the method comprising:
providing a TO-can header assembly comprising:
a header having an upper mounting surface, a lower surface, and a generally cylindrical side wall that interconnects the upper mounting surface and the lower surface;
a plurality of electrically conductive leads, each lead extending through the header and having a first end and a second end;
a ceramic heat dissipation block having at least an upper surface, a lower surface, and at least one mounting surface, the lower surface of the ceramic heat dissipation block being thermally coupled with the upper mounting surface of the header;
an electrical ground contact pad mounted on the mounting surface of the ceramic heat dissipation block, the electrical ground contact pad being in abutment with a second end of a first of the electrically conductive leads;
an electrical bias contact pad mounted on the mounting surface of the ceramic heat dissipation block, the electrical bias contact pad being in abutment with a second end of a second of the electrically conductive leads; and
a laser diode mounted on the mounting surface of the ceramic heat dissipation block, the laser diode having an anode that is electrically coupled to one of the contact pads and a cathode that is electrically coupled to the other of the contact pads;
and
providing a voltage differential between at least the first and second electrically conductive leads to cause the laser diode to be modulated, wherein as the laser diode is modulated, heat is produced by the laser diode, and wherein at least a portion of the heat produced by the laser diode passes into the ceramic heat dissipation block and then is passed from the ceramic heat dissipation block into the header.

24. The method of claim 23, wherein the lower surface of the ceramic heat dissipation block is thermally coupled with the upper mounting surface of the header by virtue of the lower surface of the ceramic heat dissipation block being in contact with the upper mounting surface of the hearder.

25. The method of claim 23, wherein the TO-can header assembly further comprises:
a heat pump having an upper surface and a lower surface, the lower surface of the heat pump being in contact with the upper mounting surface of the header, the upper surface of the heat pump being in contact with the lower surface of the ceramic heat dissipation block such that the heat pump thermally couples the lower surface of the ceramic heat dissipation block with the upper mounting surface of the header, and wherein if the heat pump is activated, the heat pump causes at least a portion of the heat that has passed from the laser diode into the ceramic heat dissipation block to be pumped from the ceramic heat dissipation block into the header.

26. The method of claim 25, wherein the TO-can header assembly further comprises:
a thermistor mounted on the mounting surface of the ceramic heat dissipation device, the thermistor sensing a temperature of the ceramic heat dissipation block, wherein the heat pump is activated when the thermistor senses that the temperature is equal to or greater than a threshold temperature, and wherein the heat pump is deactivated when the thermistor senses that the temperature is less than the threshold temperature.

27. The method of claim 26, wherein the TO-can header assembly further comprises:
an external heat sink device having a heat transfer surface that is in contact with at least a portion of the cylindrical side wall of the header, the heat transfer surface having a shape that is complimentary to a shape of the portion of the cylindrical side wall that is in contact with the heat transfer surface, and wherein at least a portion of the heat that is pumped from the ceramic heat dissipation block into the header passes from the header into the external heat sink device where the heat is dissipated.
